(19) United States
(12) Patent Application Publication
(10) Pub. No.: US 2026/0295687 A1
(43) Pub. Date: Oct. 1, 2026

(54) DRILL AND METHOD FOR MANUFACTURING MACHINED PRODUCT

(71) Applicant: KYOCERA CORPORATION, Kyoto (JP)

(72) Inventor: Masahiro YAMAMOTO, Kyoto (JP)

(21) Appl. No.: 19/477,789

(22) PCT Filed: Feb. 19, 2024
(86) PCT No.: PCT/JP2024/005717

§ 371 Date: Oct. 23, 2025

(30) Foreign Application Priority Data
Apr. 26, 2023 (JP) 2023-072546

(51) Int. Cl. B23B 51/02

(52) U.S. Cl. CPC B23B 51/02; B23B 2251/04; B23B 2251/202; B23B 2251/40

(57) ABSTRACT

A drill includes a body extending from a front end toward a rear end along a rotation axis. The body includes a first cutting edge and a first flute including a first site and a second site. In a cross section of the first flute orthogonal to the rotation axis, an angle formed by an imaginary straight line connecting the rotation axis and a front end portion and an imaginary straight line connecting the rotation axis and a lip end is a lip amount, the lip amount at the first site is larger than the lip amount at the second site.

### RELATED APPLICATIONS

The present application is a National Phase of International Application No. PCT/JP2024/005717 filed Feb. 19, 2024, which claims priority to Japanese Application No. 2023-072546, filed Apr. 26, 2023.

### TECHNICAL FIELD

The present disclosure relates to a drill used for cutting work and a method for manufacturing a machined product.

### BACKGROUND OF INVENTION

There is a known drill described in Patent Documents 1 to 3 as a drill used for cutting work of a workpiece such as a metal member. The drills described in these patent documents each have a cutting edge and a flute. The flutes described in these patent documents each have a radial width not constant but varied in a direction along a rotation axis for the purpose of improvement in chip dischargeability.

### CITATION LIST

### Patent Literature

Patent Document 1: JP H09-277108 A
Patent Document 2: JP 2004-090197 A
Patent Document 3: JP 2022-512198 A

### SUMMARY

A drill of an example not limited in the present disclosure includes a body having a rod shape rotatable about a rotation axis and extending from a front end toward a rear end along the rotation axis. The body includes a first cutting edge positioned at the front end, and a first flute extending from the first cutting edge. The first flute includes a first site positioned on a side of the front end, and a second site positioned on a side of the rear end relative to the first site. Here, in a cross section of the first flute orthogonal to the rotation axis, an end at a frontmost position of the first flute in a rotational direction of the rotation axis is a front end portion, a site of the first flute from the front end portion to an end on a heel side is an outer site, an end at a rearmost position of the outer site in the rotational direction is a lip end, and an angle formed by an imaginary straight line connecting the rotation axis and the front end portion and an imaginary straight line connecting the rotation axis and the lip end is defined as a lip amount. At this time, the lip amount at the first site is larger than the lip amount at the second site.

### BRIEF DESCRIPTION OF THE DRAWINGS

FIG. 1 is a perspective view illustrating a drill according to one embodiment of the present disclosure.

FIG. 2 is an enlarged view of a region II illustrated in FIG. 1.

FIG. 3 is a view of the drill illustrated in FIG. 1 as viewed from a side of a front end.

FIG. 4 is a side view of the drill illustrated in FIG. 3 as viewed from an IV direction.

FIG. 5 is an enlarged view of a region V illustrated in FIG. 4.

FIG. 6 is a side view of the drill illustrated in FIG. 3 as viewed from a VI direction.

FIG. 7 is a cross-sectional view of the drill illustrated in FIG. 6 taken along line VII-VII.

FIG. 8 is a cross-sectional view of the drill illustrated in FIG. 6 taken along line VIII-VIII.

FIG. 9 is a cross-sectional view of the drill illustrated in FIG. 6 taken along line IX-IX.

FIG. 10 is the same cross-sectional view as that of FIG. 7.

FIG. 11 is the same cross-sectional view as that of FIG. 8.

FIG. 12 is a schematic view illustrating one process of a manufacturing method of a machined product in one embodiment of the present disclosure.

FIG. 13 is a schematic view illustrating one process of a manufacturing method of a machined product in one embodiment of the present disclosure.

FIG. 14 is a schematic view illustrating one process of a manufacturing method of a machined product in one embodiment of the present disclosure.

### DESCRIPTION OF EMBODIMENTS

Hereinafter, a drill according to an embodiment that is an example of the present disclosure will be described in detail with reference to the drawings. Note that for ease of description, each of the drawings referenced below is a simplified drawing illustrating only main parts required for describing the present invention among the components of the embodiment. Accordingly, the drill of the present disclosure can include any component not illustrated in each of the drawings referenced in the present description. The dimensions of the members in each of the drawings do not faithfully represent the actual dimensions of the components, the dimension ratios of the respective members, and the like.

A chip generated at a front end of a known drill is sent from a side of a front end to a side of a rear end through a flute, and discharged to the outside at a site on the side of the rear end in the flute. Here, for example, regarding the drills described in Patent Documents 1 to 3, only a simple improvement in chip dischargeability is focused. Therefore, there is a possibility that the chip ejects to the outside before the chip is sent to the site on the side of the rear end of the flute. This can be a cause of damage to an inner peripheral surface of a machined bore.

An object of one aspect of the present disclosure is to provide a drill having improved chip dischargeability while suppressing an influence on an inner peripheral surface of a machined bore.

### Schematic Configuration of Drill

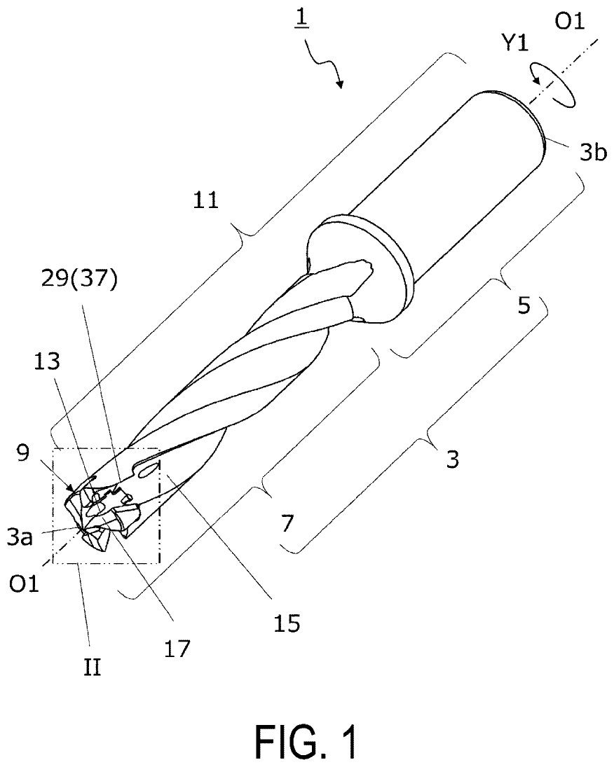

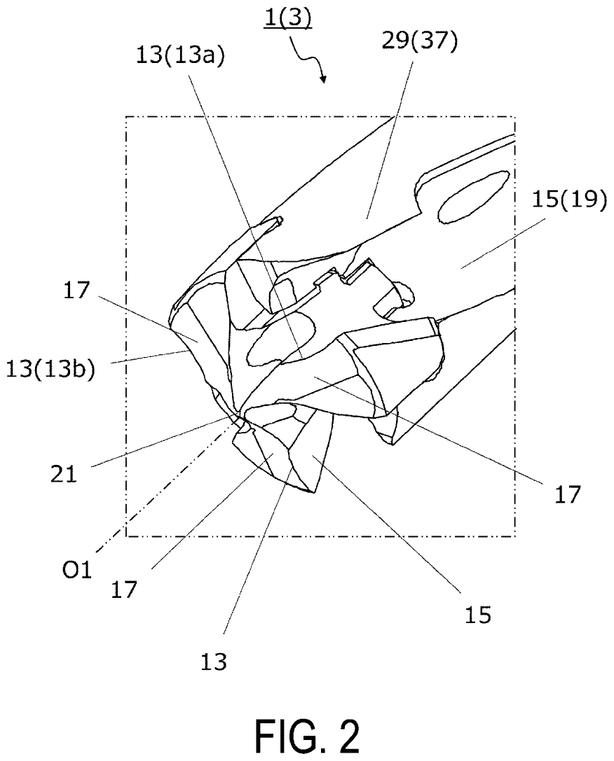

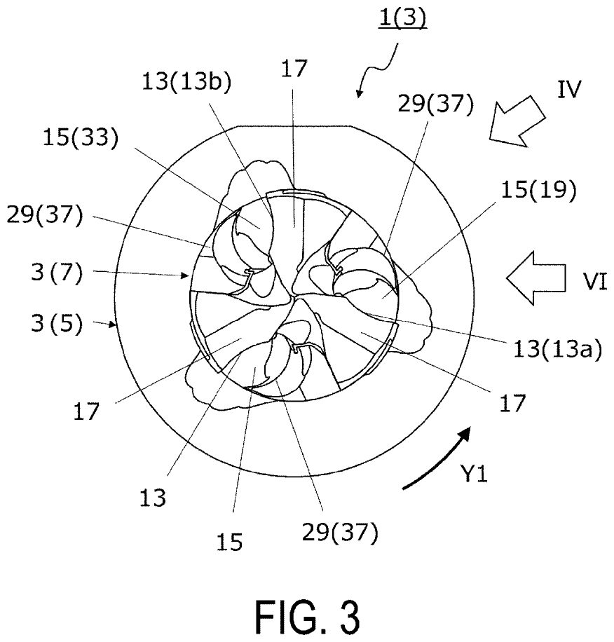

A schematic configuration of a drill 1 according to the present embodiment will be described with reference to FIGS. 1 to 3. FIG. 1 is a perspective view illustrating the drill according to one embodiment of the present disclosure. FIG. 2 is an enlarged view of the region II illustrated in FIG. 1. FIG. 3 is a front view of an insert illustrated in FIG. 2 as viewed from the side of the front end.

The drill 1 according to an example of the present disclosure includes a body 3 having a rod shape rotatable about a rotation axis O1 as illustrated in FIGS. 1 to 3. The body 3 extends from a front end 3a toward a rear end 3b along the rotation axis O1. The body 3 according to the present embodiment includes a shank 5 to be gripped by a rotating spindle or the like of a machine tool, and a cutting portion 7 called a body positioned on a side of the front end 3a with respect to this shank 5.

The shank 5 is a site designed according to the shape of a spindle or the like in the machine tool. The cutting portion 7 is a site that comes into contact with a workpiece and is a site that plays a main role in cutting work of the workpiece. Note that an arrow Y1 illustrated in FIG. 1 and the like indicates a rotational direction Y1 of the drill 1 (body 3).

The drill 1 according to the present embodiment has a configuration in which a site on the side of the front end 3a of the cutting portion 7 is detachable from a site on the side of the rear end 3b. In this case, the site on the side of the front end 3a of the body 3 is called an insert 9, and the site on the side of the rear end 3b of the body 3 is called a holder 11. As a matter of course, even if the drill 1 according to an example of the present disclosure includes the body 3 not having the configuration as described above but a configuration including one member, that is, a configuration generally called a solid drill, there is no problem at all.

Hereinafter, the drill 1 including the body 3 with the insert 9 attached to the holder 11 will be described in detail. Note that in the following description, the body 3, the cutting portion 7, and the insert 9 may be replaced unless they are contradictory. The configuration (technical idea) of the body 3 including the insert 9 described below can also be applied to the body 3 (or the cutting portion 7) including a solid drill configuration. In FIG. 2 and the like, a reference sign for the body 3 is also indicated for the drill 1.

The body 3 (the cutting portion 7 or the insert 9) includes a cutting edge 13 positioned at the front end 3a and a flute 15 extending from the cutting edge 13. The body 3 further includes a flank face 17 positioned at the front end 3a. The cutting edge 13 is positioned at a front edge in the rotational direction Y1 of the flank face 17. In other words, the flank face 17 extends from the cutting edge 13 toward a rear in the rotational direction Y1 (the opposite side in the rotational direction Y1).

The flank face 17, the cutting edge 13, and the flute 15 are not limited to a specific number. In the drill 1 of the example not limited illustrated in FIG. 2, the cutting portion 7 includes three flank faces 17, three cutting edges 13, and three flutes 15, and has a configuration of what is called a three-flute drill. Even if the drill 1 according to an example of the present disclosure includes a configuration of what is called a two-flute drill in which the cutting portion 7 includes two flank faces 17, two cutting edges 13, and two flutes 15, there is no problem at all.

The plurality of flank faces 17, the plurality of cutting edges 13, and the plurality of flutes 15 may be in a positional relationship rotationally symmetric about the rotation axis O1. In the drill 1 (the insert 9) of the example not limited illustrated in FIG. 3, the three flank faces 17 are positioned in 120° rotational symmetry. Similarly, in the example not limited illustrated in FIG. 3, the three cutting edges 13 are positioned in 120° rotational symmetry, and the three flutes 15 are positioned in 120° rotational symmetry.

Note that since the three flank faces 17 are configured to be rotationally symmetric, focusing on one of the three flank faces 17, a detailed description of the other two flank faces 17 will be omitted. Similarly, since the three cutting edges 13 and the three flutes 15 are each configured to be rotationally symmetric, focusing on one of the three cutting edges 13 and one of the three flutes 15. Hereinafter, the cutting edge 13 and the flute 15 to be focused are a first cutting edge 13a and a first flute 19. Even if the other two cutting edges 13 and the other two flutes 15 have a configuration described below, there is no problem at all.

The first cutting edge 13a is positioned at the front end 3a of the body 3, and extends from the rotation axis O1 toward an outer periphery when the body 3 is viewed from the side of the front end 3a, in other words, when viewed from the front end.

Usually, the cutting edge 13 is positioned at an intersection of the flank face 17 and a rake face. However, in a case of including the plurality of cutting edges 13, it may be difficult to provide a rake face near the rotation axis O1 from the viewpoint of securing the core thickness of the body 3. Therefore, near the rotation axis O1, the cutting edge 13 is formed by an intersection of the plurality of flank faces 17 corresponding to the plurality of cutting edges 13. Such a site is called a chisel edge 21. For example, a site of the first cutting edge 13a positioned near the rotation axis O1 is the chisel edge 21.

### Details of Drill

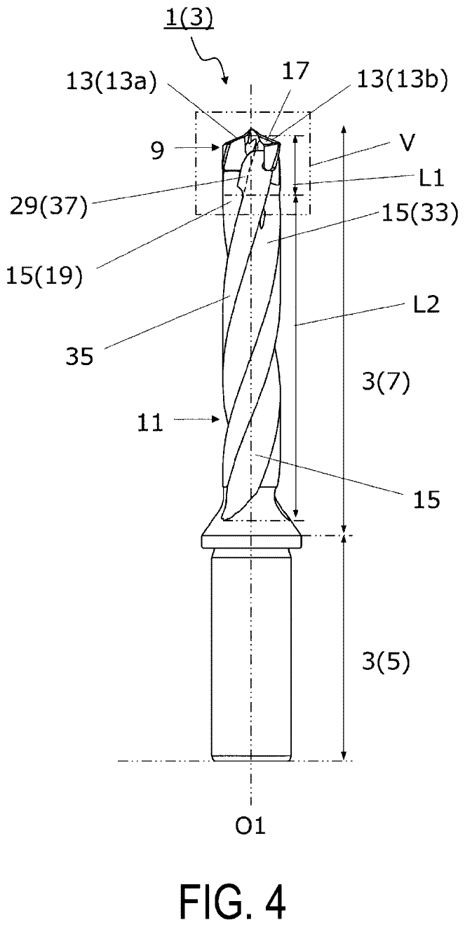

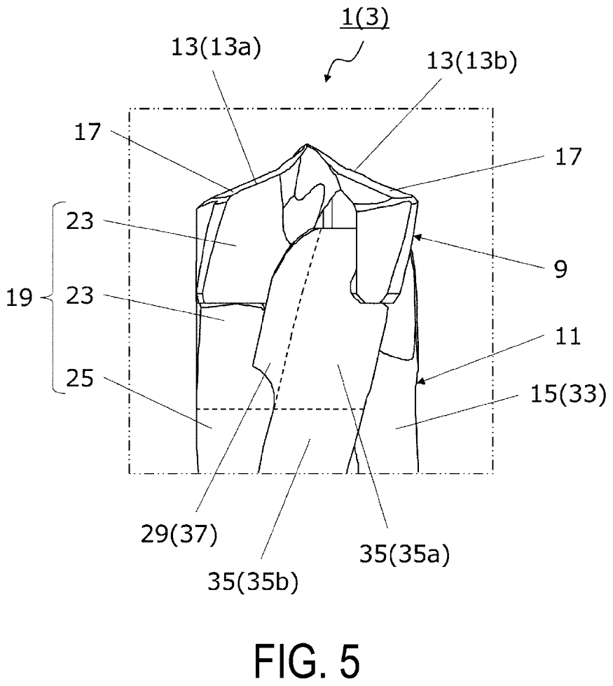

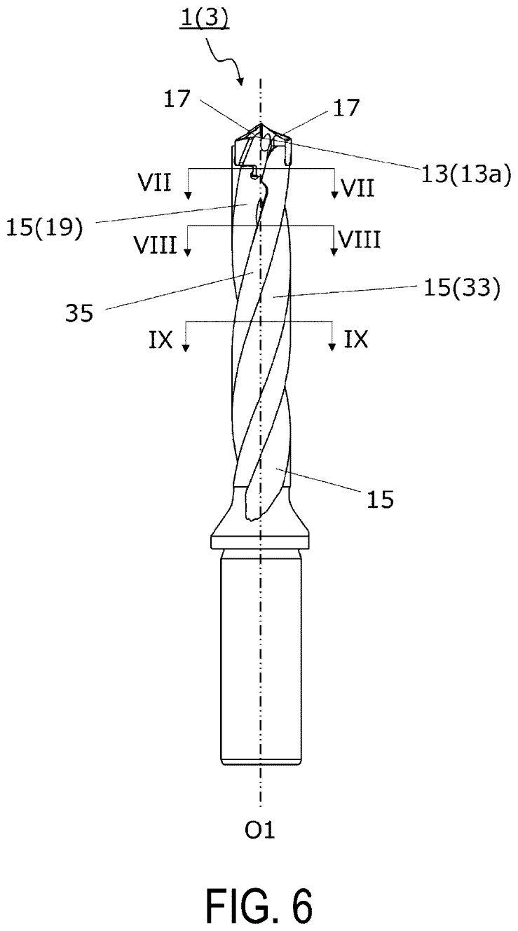

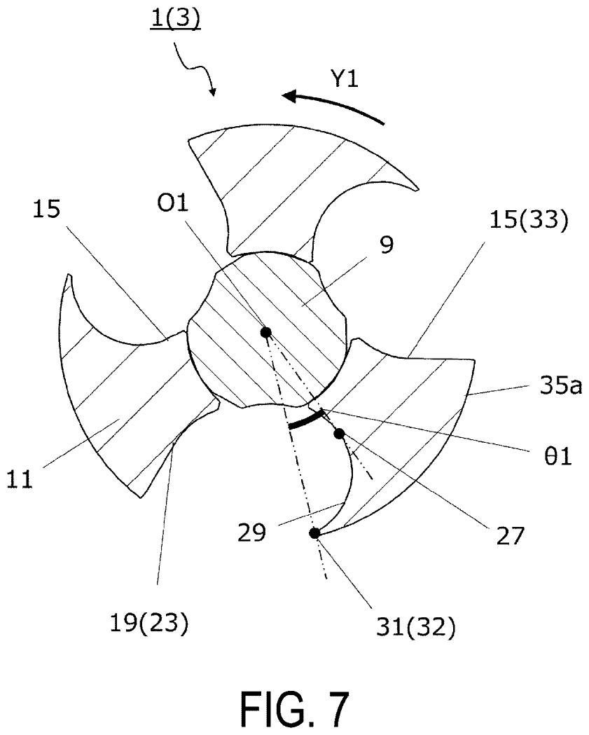

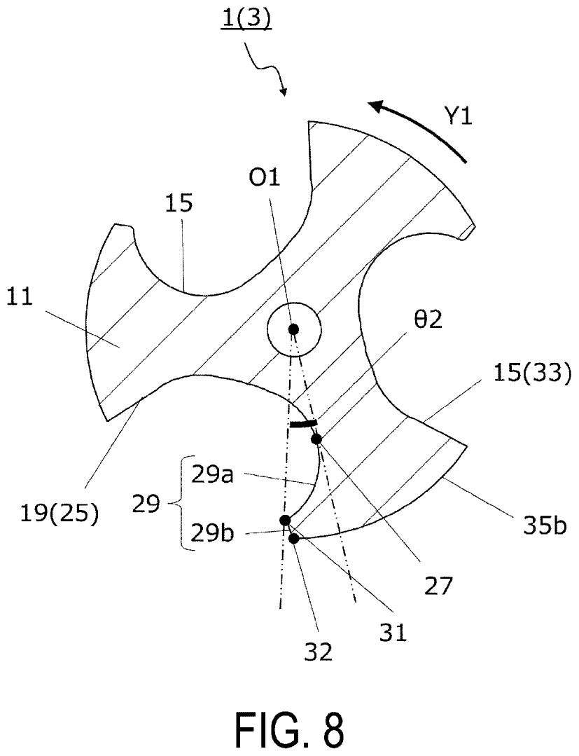

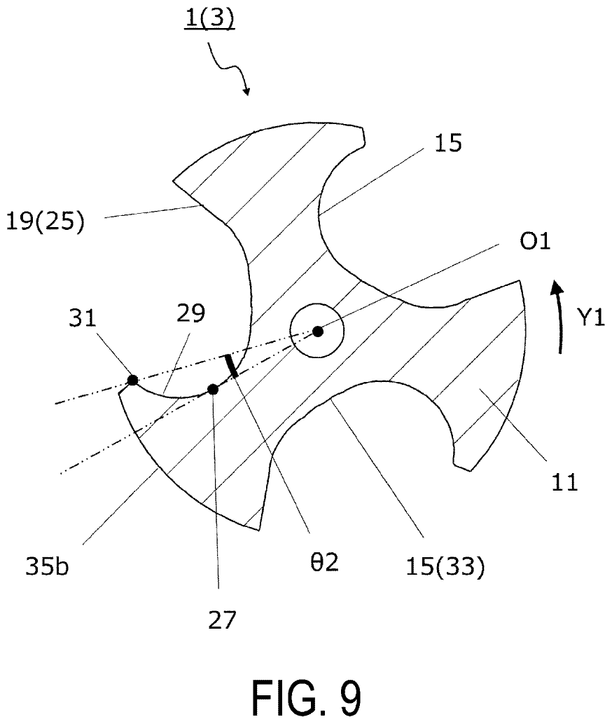

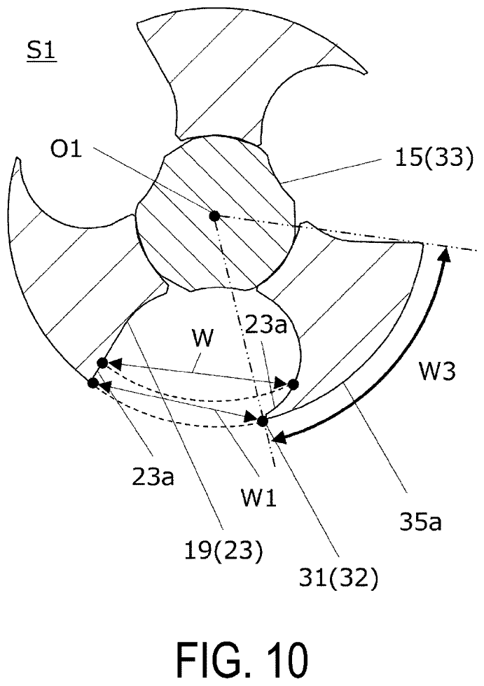

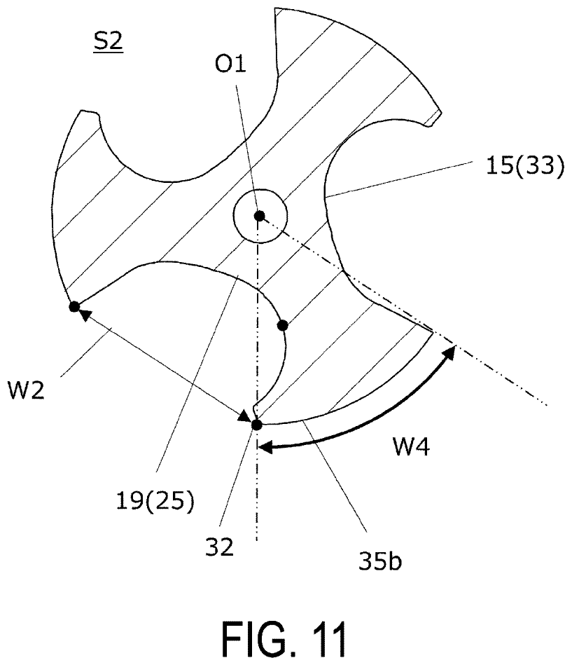

The drill 1 according to the present embodiment will be described in detail with reference to FIGS. 4 to 11 together with FIGS. 1 to 3. FIG. 4 is a side view of the drill illustrated in FIG. 2 as viewed from the IV direction. FIG. 5 is an enlarged view of the region V illustrated in FIG. 4. FIG. 6 is a side view of the drill illustrated in FIG. 2 as viewed from the VI direction. FIG. 7 is a cross-sectional view of the drill illustrated in FIG. 6 taken along line VII-VII. FIG. 8 is a cross-sectional view of the drill illustrated in FIG. 6 taken along line VIII-VIII. FIG. 9 is a cross-sectional view of the drill illustrated in FIG. 6 taken along line IX-IX. FIG. 10 is the same cross-sectional view as that of FIG. 7. FIG. 11 is the same cross-sectional view as that of FIG. 8.

As illustrated in FIGS. 1 to 11, the first flute 19 included in the cutting portion 7 extends from the first cutting edge 13a toward the rear end 3b. The first flute 19 is a site used for discharging a chip generated at the first cutting edge 13a to the outside. The first flute 19 does not need to extend to the rear end 3b of the body 3. As in the example illustrated in FIG. 1, the first flute 19 may be formed only in the cutting portion 7 and needs not be formed in the shank 5. The first flute 19 may extend spirally around the rotation axis O1 as in the example not limited illustrated in FIG. 1.

The first flute 19 in the example not limited illustrated in FIG. 5 includes a first site 23 positioned on the side of the front end 3a and a second site 25 positioned on the side of the rear end 3b relative to the first site 23. In the drill 1 according to the present embodiment, as illustrated in FIG. 5, the first site 23 may include a groove extending on the side of the rear end 3b from a rake face positioned along a portion on the outer peripheral side of the first cutting edge 13a in the insert 9, and a groove positioned on the side of the front end 3a of the holder 11.

Here, in a cross section S (e.g., a cross section illustrated in FIGS. 7 to 11) orthogonal to the rotation axis O1 in the drill 1 of the present embodiment, regarding the first flute 19, a front end portion 27, an outer site 29, a lip end 31, and a lip amount 0 are defined as follows.

In the cross section S described above, the front end portion 27 is an end at a frontmost position of the first flute 19 in the rotational direction Y1 of the rotation axis O1. The front end portion 27 is specified in each cross section. Specifically, in each cross section, a contact when a tangent is drawn from a center point corresponding to the rotation axis O1 with respect to a recessed curved line corresponding to the surface of the first flute 19 is the front end portion 27.

In the cross section S described above, the outer site 29 is a site of the first flute 19 from the front end portion 27 to an end 32 on the heel side (see FIGS. 7 and 8). The outer site 29 is formed such that at least a part thereof is positioned rearward in the rotational direction Y1 from the front end portion 27 toward the outer periphery, and has what is called a configuration of a “lip (engaging portion)”.

Note that in the cross section S, the “end 32 on the heel side” means an end positioned frontward in the rotational direction Y1 of the first flute 19 forming an opening portion. Specifically, in the cross section S (cross section orthogonal to the rotation axis O1 in the drill 1), a portion where the first flute 19 and the outer peripheral surface of the body 3 intersect is an edge section (rim section) of the opening portion formed by the first flute 19.

There are two edge sections of the opening portion of the first flute 19, i.e., one positioned frontward in the rotational direction Y1 and the other positioned rearward in the rotational direction Y1. Of the two edge sections included in the opening portion in the cross section S, the one positioned frontward in the rotational direction Y1 is the “end 32 on the heel side”.

In the cross section S, the lip end 31 is an end at a rearmost position of the outer site 29 in the rotational direction Y1. The lip amount θ is an angle formed by an imaginary straight line connecting the rotation axis O1 and the front end portion 27 and an imaginary straight line connecting the rotation axis O1 and the lip end 31. At this time, as illustrated in FIGS. 7 and 8, a lip amount 01 at the first site 23 may be larger than a lip amount 02 at the second site 25.

In the drill 1 according to the present embodiment, each of the front end portion 27, the outer site 29, and the lip end 31 is specified as a part of the holder 11. In a case where the first flute 19 includes the outer site 29 described above, the outer site 29 can be a barrier against the chip ejecting when the chip is about to eject to the outside. Therefore, accidental chip ejection is less likely to occur, and the influence of the chip on the inner peripheral surface of the machined bore can be suppressed.

In particular, at the first site 23 positioned on the side of the front end 3a of the first flute 19, the chip flows at a timing immediately after the chip is generated at the first cutting edge 13a. Therefore, the flow of the chip tends to be unstable, but the lip amount 01 at the first site 23 is relatively large. Therefore, accidental chip ejection can be less likely to occur. In addition, the chip tends to be easily curled by the outer site 29 at the first site 23. Therefore, the chip is easily collected, and the chip is easily sent from the side of the front end 3a to the side of the rear end 3b through the first flute 19.

Furthermore, since the lip amount θ2 at the second site 25 is relatively small, the chip is easily discharged to the outside on the side of the rear end 3b. In a case that the lip amount 01 at the first site 23 is larger than the lip amount θ2 at the second site 25 in this manner, the chip dischargeability is improved while suppressing an influence on an inner peripheral surface of a machined bore.

Note that since the lip amount θ2 at the second site 25 may be relatively small, the lip amount 02 at the second site 25 may be 0, that is, the outer site 29 needs not be formed at the second site 25. In other words, the end 32 on the heel side at the second site 25 may be at a frontmost position of the second site 25 in the rotational direction Y1.

Note that since the first flute 19 includes the first site 23 and the second site 25, the lip amount θ (θ1 and θ2) may be respectively measured at a cross section S1 (e.g., the cross section illustrated in FIG. 7) of the first site 23 orthogonal to the rotation axis O1 and a cross section S2 (e.g., the cross section illustrated in FIG. 8) of the second site 25 orthogonal to the rotation axis O1, and the magnitudes of these lip amounts θ1 and θ2 may be compared. The lip amounts θ1 and θ2 are not limited to specific values. For example, the lip amount θ1 can be set to 10° to 30°. The lip amount θ2 can be set to 0° to 20°.

Note that although the first site 23 is positioned on the side of the front end 3a as compared with the second site 25, at this time, the first site 23 may include an end of the first flute 19 on the side of the front end 3a. At the timing immediately after the chip is generated at the first cutting edge 13a, the outer site 29 at the first site 23 easily suppresses the chip from accidentally ejecting.

In the cross section S1 orthogonal to the rotation axis O1 and passing through the first site 23 in the drill 1 of the present embodiment, a distance between two intersection points (two edge sections included in the opening portion in the cross section S described above) where the first flute 19 and the outer peripheral surface of the body 3 intersect is defined as an opening width W1 (see FIG. 10) of the first site 23. In the cross section S2 orthogonal to the rotation axis O1 and passing through the second site 25 in the drill 1 of the present embodiment, a distance between two intersection points where the first flute 19 and the outer peripheral surface of the body 3 intersect is defined as an opening width W2 (see FIG. 11) of the second site 25.

In the drill 1 according to the present embodiment, the opening width W1 may be smaller than the opening width W2. If the opening width W1 described above at the first site 23 is relatively small, accidental chip ejection is further less likely to occur at the first site 23. If the opening width W2 at the second site 25 is relatively large, the chip is more easily discharged to the outside on the side of the rear end 3b at the second site 25.

As illustrated in FIG. 8, in the drill 1 of the present embodiment, in the cross section S2, the outer site 29 at the second site 25 of the first flute 19 may include a lip 29a, which is a site from the front end portion 27 to the lip end 31, and an inclined surface 29b, which is a site from the lip end 31 to the end 32 on the heel side. In the cross section S2, the lip 29a may have a recessed curved line shape, and the inclined surface 29b may have a linear shape. In the inclined surface 29b, the end 32 on the heel side may be positioned more frontward in the rotational direction Y1 than the lip end 31.

As described above, the cutting portion 7 in the example not limited illustrated in FIG. 1 includes the plurality of (specifically, three) flank faces 17, the cutting edges 13, and the flutes 15. At this time, the cutting edge 13 positioned frontward in the rotational direction Y1 with respect to the first cutting edge 13a is defined as a second cutting edge 13b, the flute 15 extending from this second cutting edge 13b toward the rear end 3b is defined as a second flute 33, and a region positioned between the first flute 19 and the second flute 33 in the outer peripheral surface of the cutting portion 7 is defined as a first outer peripheral surface 35.

In the first outer peripheral surface 35, a region positioned between the first site 23 and the second flute 33 is defined as a first region 35a, and in the first outer peripheral surface 35, a region positioned between the second site 25 and the second flute 33 is defined as a second region 35b. In other words, the first outer peripheral surface 35 includes the first region 35a adjacent to the first site 23 and the second region 35b adjacent to the second site 25.

At this time, the first region 35a may include a protruding portion 37 protruding rearward in the rotational direction Y1. In other words, a ridge line of the first flute 19 and the first outer peripheral surface 35 may include a site positioned on the side of the front end 3a and protruding rearward in the rotational direction Y1. This protruding portion 37 may constitute the outer site 29 at the first site 23 described above.

In a case that the outer site 29 is configured in this manner, for example, a region excluding the outer site 29 at the first site 23 and a region excluding the outer site 29 at the second site 25 are easily configured to be similar to each other. Therefore, the flow of the chip from the first site 23 to the second site 25 tends to be smooth.

In the cross section S1, a length (of a curve) from an end point on a front side to an end point on a rear side (corresponding to the lip end 31 or the end 32 on the heel side) in the rotational direction Y1 of the first region 35a is defined as W3 (see FIG. 10). In the cross section S2, a length (of a curve) from an end point on the front side to an end point on the rear side (corresponding to the end 32 on the heel side) in the rotational direction Y1 of the second region 35b is defined as W4 (see FIG. 11).

In the drill 1 according to the present embodiment, the length W3 may be larger than the length W4. Specifically, the length W3 of the first region 35a may be larger than the length W4 of the second region 35b by the amount of the protruding portion 37 protruding rearward in the rotational direction Y1.

A length L1 of the first site 23 in the direction along the rotation axis O1 may be larger than a length L2 of the second site 25 in the direction along the rotation axis O1, or may be smaller than the length L2 of the second site 25 as in the example not limited illustrated in FIG. 4. In a case that the length L1 of the first site 23 is smaller than the length L2 of the second site 25, the degree of freedom in machining of the drill 1 is increased.

The flow of the chip generated at the cutting edge 13 tends to be unstable at a timing immediately after the chip is generated at the cutting edge 13. Therefore, the length L1 of the first site 23 does not need to be set to be excessively large. Here, since the outer site 29 is smaller at the second site 25 than at the first site 23, a larger space in the cross sections S (S1 and S2) relatively orthogonal to the rotation axis O1 is easier to be secured at the second site 25 than at the first site 23. Therefore, the possibility of occurrence of chip clogging can be reduced while suppressing accidental chip ejection.

Here, in the cross section S orthogonal to the rotation axis O1 in the drill 1, an imaginary circle having an arbitrary radius centered on the rotation axis O1 is assumed. In the cross section S, a partial open space formed partially surrounded by the first flute 19 or partially surrounded by the first flute 19 and the surface of a shaft of the insert 9 is referred to as a groove space.

In a case that two intersection points where the imaginary circle and the first flute 19 intersect can be specified, the distance between the two intersection points is referred to as a groove width W. The groove width W is a groove width of the groove space at a depth position corresponding to the radius of the imaginary circle.

In general, a groove space in a known drill may have a shape in which a groove width monotonously increases from a groove bottom (location close to a rotation axis) to an edge section (location continuous with an outer peripheral surface) of an opening portion in a cross section orthogonal to the rotation axis.

On the other hand, in the drill 1 according to the example of the present disclosure, in the cross section S1 of the first flute 19 orthogonal to the rotation axis O1, the first site 23 may include a constriction 23a where the groove width W decreases with an increasing distance from the rotation axis O1. In other words, the first site 23 may include the constriction 23a where the opening portion (the groove space) is narrowed with an increasing distance from the rotation axis O1.

The constriction 23a may be positioned on each of the front side and the rear side in the rotational direction Y1 at the first site 23. The constriction 23a positioned on the front side in the rotational direction Y1 may be a part of the outer site 29. In a case that the first site 23 includes such a constriction 23a, accidental chip ejection can be further suppressed.

While the first site 23 includes the constriction 23a described above, the second site 25 needs not include the constriction 23a as described above. That is, at the second site 25, the groove width W may monotonically increase with an increasing distance from the rotation axis O1 in the cross section S2. In this case, since good chip dischargeability at the second site 25 is secured, chip clogging hardly occurs.

### Configuration Example

In the body 3 of the present embodiment, for example, the outer diameter of the cutting portion 7 is set to 6 mm to 42.5 mm. For example, if the length of the axis (length of the cutting portion 7) is L and the diameter (outer diameter of the cutting portion 7) is D, the body 3 of the present embodiment is set to L=1 D to 12 D.

Examples of the material of the body 3 (insert 9) can include a cemented carbide alloy and a cermet. Examples of the composition of the cemented carbide alloy can include WC-Co, WC-TiC—Co, and WC-TiC—TaC—Co, for example. Here, WC, TiC, and TaC may be hard particles, and Co may be a binder phase.

The cermet may be a sintered composite material in which metal is composited with a ceramic component. Examples of the cermet can include a titanium compound in which titanium carbide (TiC) or titanium nitride (TiN) is a main component. Needless to say, the material of the body 3 is not limited to the above composition.

The surface of the body 3 may be coated with a coating film using the chemical vapor deposition (CVD) method or the physical vapor deposition (PVD) method. Examples of the composition of the coating film include titanium carbide (TiC), titanium nitride (TiN), titanium carbonitride (TiCN), and alumina (Al₂O3).

In a case that the body 3 includes the insert 9 and the holder 11, examples of the material of the holder 11 can include aluminum, carbon steel, alloy steel, stainless steel, cast iron, and non-ferrous metal.

### Manufacturing Method of Machined Product

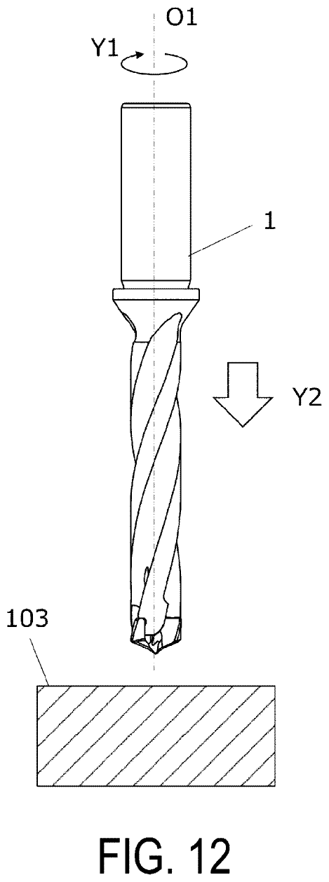

Next, a manufacturing method of a machined product 101 on one surface not limited of the present disclosure will be described with reference to FIGS. 12 to 14. The machined product 101 may be produced by performing cutting work on a workpiece 103. The manufacturing method of the machined product 101 may include the following processes (1) to (4).
(1) Process of arranging the drill 1 above the workpiece 103 having been prepared (see FIG. 12).
(2) Process of rotating the drill 1 in the direction of the arrow Y1 about the rotation axis O1 and bringing the drill 1 close to the workpiece 103 in a Y2 direction (see FIG. 12).

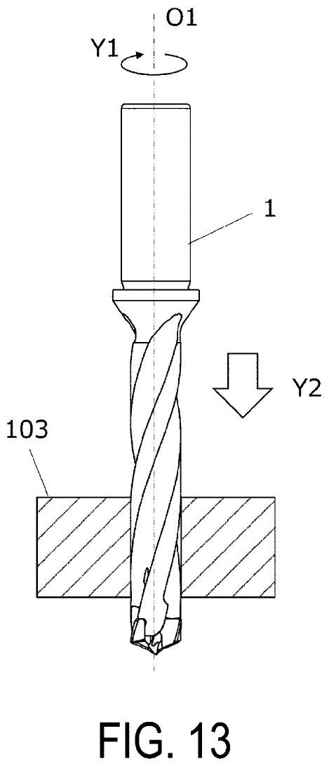

In the processes (1) and (2) described above, for example, the workpiece 103 may be fixed on a table of a machine tool attached with the drill 1, and brought close to the workpiece 103 with the drill 1 being rotated. Note that in the process (2), the workpiece 103 and the drill 1 may be relatively close to each other, and for example, the workpiece 103 may be close to the drill 1.
(3) Process of bringing the drill 1 close to the workpiece 103, thereby bringing the drill 1 that is rotating into contact with a desired position on the surface of the workpiece 103 to form a machined hole 105 in the workpiece 103 (see FIG. 13).

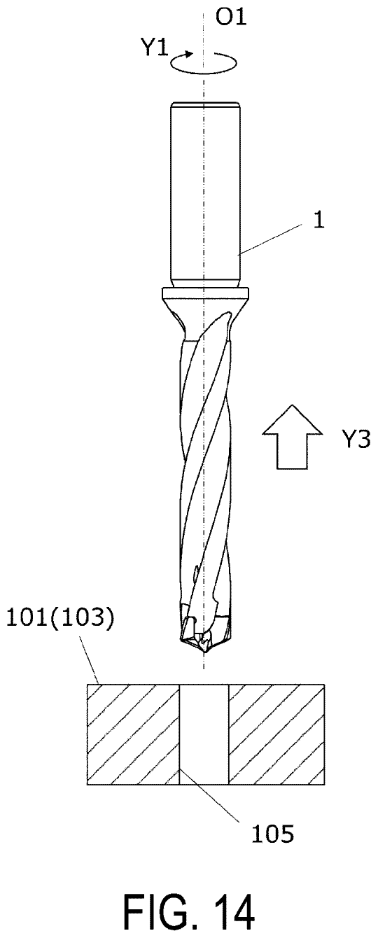

In the process (3) described above, cutting work may be performed such that at least a part of the cutting portion 7 in the body 3 is positioned in the machined hole 105. In the process (3), the shank 5 of the body 3 may be set to be positioned outside the machined hole 105. From the viewpoint of obtaining a good finished surface, a part of the cutting portion 7 on the side of the rear end 3b can be set to be positioned outside the machined hole 105. The part described above can be caused to function as a margin region for chip discharge, and excellent chip dischargeability can be achieved via the region.
(4) Process of separating the drill 1 from the workpiece 103 in the Y3 direction (see FIG. 14).

Also in the process (4) described above, similarly to the process (2) described above, the workpiece 103 and the drill 1 may be relatively separated, and for example, the workpiece 103 may be separated from the drill 1.

In a case that the above process is performed, the machined product 101 having the machined hole 105 can be obtained with high accuracy.

Note that when cutting work of the workpiece 103 is performed a plurality of times, and for example, when a plurality of the machined holes 105 is formed with respect to one workpiece 103, a process of bringing the cutting edge 13 of the drill 1 into contact with different locations of the workpiece 103 while maintaining the state in which the drill 1 is rotated may be repeated.

Examples of the material of the workpiece 103 can include aluminum, carbon steel, alloy steel, stainless steel, cast iron, and non-ferrous metal.

### Summary

A drill according to a first aspect of the present disclosure includes a body having a rod shape rotatable about a rotation axis and extending from a front end toward a rear end along the rotation axis. The body includes a first cutting edge positioned at the front end, and a first flute extending from the first cutting edge. The first flute includes a first site positioned on a side of the front end, and a second site positioned on a side of the rear end relative to the first site. In a cross section of the first flute orthogonal to the rotation axis, an end at a frontmost position of the first flute in a rotational direction of the rotation axis is a front end portion, a site of the first flute from the front end portion to an end on a heel side (edge section positioned frontward in the rotational direction of a pair of edge sections) is an outer site, an end at a rearmost position of the outer site in the rotational direction is a lip end, and an angle formed by an imaginary straight line connecting the rotation axis and the front end portion and an imaginary straight line connecting the rotation axis and the lip end is a lip amount, the lip amount at the first site is larger than the lip amount at the second site.

A drill according to a second aspect of the present disclosure is based on the first aspect, and includes an element in which a distance between two intersection points where the first flute and an outer peripheral surface of the body intersect in a cross section of the first site orthogonal to the rotation axis is an opening width of the first site, and a distance between two intersection points where the first flute and an outer peripheral surface of the body intersect in a cross section of the second site orthogonal to the rotation axis is an opening width of the second site, and an opening width of the first site is smaller than an opening width of the second site.

A drill according to a third aspect of the present disclosure is based on the first or second aspect, and includes an element in which the body further includes a second cutting edge positioned frontward in the rotational direction with respect to the first cutting edge, a second flute extending from the second cutting edge, and an outer peripheral surface positioned between the first flute and the second flute, the outer peripheral surface includes a first region adjacent to the first site, and a second region adjacent to the second site, and the first region has a protruding portion protruding rearward in the rotational direction.

A drill according to a fourth aspect of the present disclosure is based on the third aspect, and includes an element in which a length from an end point on a front side to an end point on a rear side in the rotational direction of the first region in a cross section of the first site orthogonal to the rotation axis is longer than a length from an end point on a front side to an end point on a rear side in the rotational direction of the second region in a cross section of the second site orthogonal to the rotation axis.

A drill according to a fifth aspect of the present disclosure is based on any one aspect of the first to fourth aspects, and includes an element in which a length of the first site in a direction along the rotation axis is smaller than a length of the second site in a direction along the rotation axis.

A drill according to a sixth aspect of the present disclosure is based on any one aspect of the first to fifth aspects, and includes an element in which the first site has a constriction where a groove width decreases with an increasing distance from the rotation axis in a cross section of the first site orthogonal to the rotation axis.

A drill according to a seventh aspect of the present disclosure is based on the sixth aspect, and includes an element in which the second site has a groove width increasing with an increasing distance from the rotation axis.

A drill according to an eighth aspect of the present disclosure is based on any one aspect of the first to seventh aspects, and includes an element in which the first site includes an end on a side of the front end of the first flute.

A manufacturing method of a machined product according to a ninth aspect of the present disclosure includes: rotating the drill of any one aspect of the first to eighth aspects about the rotation axis; bringing the drill that is rotating into contact with a workpiece; and separating the drill from the workpiece.

### Supplementary Notes

The invention according to the present disclosure has been described above based on the various drawings and embodiments. However, the invention according to the present disclosure is not limited to each embodiment described above. That is, the embodiments of the invention according to the present disclosure can be varied in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or corrections based on the present disclosure. Note that these variations or corrections are included within the scope of the present disclosure.

1. A drill comprising:
a body having a rod shape rotatable about a rotation axis and extending from a front end toward a rear end along the rotation axis, wherein
the body comprises
a first cutting edge positioned at the front end, and
a first flute extending from the first cutting edge,
the first flute comprises
a first site, and
a second site positioned on a side of the rear end relative to the first site,
in a cross section of the first flute orthogonal to the rotation axis,
an end at a frontmost position of the first flute in a rotational direction of the rotation axis is a front end portion,
a site of the first flute from the front end portion to an end on a heel side is an outer site,
an end at a rearmost position of the outer site in the rotational direction is a lip end, and
an angle formed by an imaginary straight line connecting the rotation axis and the front end portion and an imaginary straight line connecting the rotation axis and the lip end is a lip amount, and
the lip amount at the first site is larger than the lip amount at the second site.

2. The drill according to claim 1, wherein
a distance between two intersection points where the first flute and an outer peripheral surface of the body intersect in a cross section of the first site orthogonal to the rotation axis is a first opening width,
a distance between two intersection points where the first flute and an outer peripheral surface of the body intersect in a cross section of the second site orthogonal to the rotation axis is a second opening width, and
the first opening width is smaller than the second opening width.

3. The drill according to claim 1, wherein
the body further comprises
a second cutting edge positioned frontward in the rotational direction with respect to the first cutting edge,
a second flute extending from the second cutting edge, and
an outer peripheral surface positioned between the first flute and the second flute,
the outer peripheral surface comprises
a first region adjacent to the first site, and
a second region adjacent to the second site, and
the first region has a protruding portion protruding rearward in the rotational direction.

4. The drill according to claim 3, wherein a length from an end point on a front side to an end point on a rear side in the rotational direction of the first region in a cross section of the first site orthogonal to the rotation axis is longer than a length from an end point on a front side to an end point on a rear side in the rotational direction of the second region in a cross section of the second site orthogonal to the rotation axis.

5. The drill according to claim 1, wherein a length of the first site in a direction along the rotation axis is smaller than a length of the second site in a direction along the rotation axis.

6. The drill according to claim 1, wherein the first site comprises a constriction where a groove width decreases with an increasing distance from the rotation axis in a cross section of the first site orthogonal to the rotation axis.

7. The drill according to claim 6, wherein the second site has a groove width increasing with an increasing distance from the rotation axis.

8. The drill according to claim 1, wherein the first site includes an end on a side of the front end of the first flute.

9. A method for manufacturing a machined product, the method comprising:
rotating the drill according to claim 1 about the rotation axis;
bringing the drill that is rotating into contact with a workpiece; and
separating the drill from the workpiece.
